(19) United States
(12) Patent Application Publication
(10) Pub. No.: US 2016/0323490 A1
(43) Pub. Date: Nov. 3, 2016

(54) EXTENSIBLE, AUTOMATICALLY-SELECTED COMPUTATIONAL PHOTOGRAPHY SCENARIOS

(71) Applicant: Microsoft Technology Licensing, LLC, Redmond, WA (US)

(72) Inventors: Naveen Thumpudi, Redmond, WA (US); Denis Demandolx, Bellevue, WA (US); Sandeep Kanumuri, Bellevue, WA (US); Suhib Alsisan, Bellevue, WA (US); William Guyman, Medina, WA (US); Yijie Wang, Bellevue, WA (US)

(21) Appl. No.: 14/698,632

(22) Filed: Apr. 28, 2015

(51) Int. Cl. H04N 5/232

(52) U.S. Cl. CPC H04N 5/232

(57) ABSTRACT

A facility for generating at least one image is described. For each of multiple registered photography scenarios, the facility determines a suitable score for the scenario based upon state of a photography device. The facility selects a scenario having a suitability score that is no lower than any other determined suitability score. The facility then captures a sequence of one or more frames in a manner specified for the selected scenario, and processes that captured sequence of frames in a manner specified for the selected scenario to obtain at least one image.

### TECHNICAL FIELD

The described technology is directed to the field of computational photography.

### BACKGROUND

Computational photography refers to the capture and algorithmic processing of digital images. This processing can produce either a single result frame—a still image—or a sequence of result frames—a video clip or animation. For example, a High Dynamic Range (“HDR”) computational photography technique involves (1) capturing a sequence of frames at different exposure levels, and (2) selectively fusing these frames into a single result frame that is often more visually appealing than any of the captured frames.

### BRIEF DESCRIPTION OF THE DRAWINGS

FIG. 1 is a block diagram showing some of the components typically incorporated in at least some of the computer systems and other devices on which the facility operates.

FIG. 2 is a flow diagram showing example acts that may be performed by the facility in some examples to take and process a photograph using an automatically-selected computational photography scenario.

FIG. 3 is a table diagram showing sample contents of a scenario table data structure used by the facility in some examples to store information about registered scenarios.

FIG. 4 is a flow diagram showing examples acts that may be performed by the facility in some examples to add a new scenario to the scenarios registered with the facility.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

A facility for generating at least one image is described. In some examples, for each of multiple registered photography scenarios, the facility determines a suitable score for the scenario based upon state of a photography device, including state of a scene as represented by one or more preview frames from the image sensor and/or information from other sensors such as ambient light sensors, gyroscopic motion sensor, accelerometer, depth sensor, etc. The facility selects a scenario having a suitability score that is no lower than any other determined suitability score. The facility then captures a sequence of frames in a manner specified for the selected scenario, and processes that captured sequence of frames in a manner specified for the selected scenario to obtain at least one image. In some examples, the selected scenario specifies a sequence of frames in a manner that is based upon state of the photography device. In some examples, the selected scenario specifies capture of a single frame.

### DETAILED DESCRIPTION

Conventional implementations of computational photography techniques in a dedicated camera, a smart phone, or other photography devices typically require explicit user selection of a particular computational photography technique, such as by interacting with physical or on-screen camera configuration controls. The inventors have recognized that this makes conventional implementations ill-suited to less sophisticated users who don't understand particular computational photography techniques and how they stand to improve photographs under certain conditions, in that these less sophisticated users are unlikely to use and gain the benefit of computational photography techniques. Even among more sophisticated users who do understand computational photography techniques, the need to explicitly select a particular computational photography technique requires a certain amount of time and effort, making it less likely that the user will be able to act quickly to capture a short-lived scene. This is even more true where conventional techniques require a user to separately adjust a number of different settings in order to use a particular computational photography technique.

In order to address these shortcomings of conventional implementations of computational photography techniques, the inventors have conceived and reduced to practice a software and/or hardware facility for automatically selecting and applying an appropriate computational photography technique—or “scenario”—such as when a user takes a photograph (“the facility”).

In some examples, for a set of the scenarios, the facility tests how suited each scenario is to present conditions. Such testing can be performed with respect to a variety of inputs, including information about preview frames from the camera's image; information from other sensors of the capture device, such as ambient light sensors, depth sensors, orientation sensors, and movement sensors; other state of the capture device, such as the state of configurable user preferences; and other information, including information retrieved wirelessly from another device by the capture device. For example, inputs from external devices and sensors may provide complementary or new information about such photographic considerations as lighting, scene content, structure, motion, depth, objects, coloring, or type of image to be captured—e.g., people, action scene, crowded, macro, etc.

In various examples, the facility does this testing either in response to user action (for example, when the user presses the camera's shutter button), or continuously while the camera is active.

When the user does press the camera's shutter button, the facility automatically implements the scenario determined to be best-suited to present conditions by (1) performing a series of frame captures specified as part of the scenario, and (2) processing the captured frames to obtain one or more result frames in a manner also specified as part of the scenario. In various embodiments, this processing produces a still image, a video clip, an animation sequence, and/or a 3-D image or video clip having depth information inferred with respect to the capture sequence.

In some examples, the set of scenarios available for selection by the facility is extensible. In particular, a new scenario can be added to this set by specifying (1) a way to calculate a suited new score for the scenario based on present conditions; (2) a recipe for performing frame captures when the scenario selected or a way to compute that recipe based on present conditions; and (3) a process for processing frames captured in accordance with the recipe when the scenario is selected. In some examples, a scenario may further be accompanied by one or more conditions that determine when the scenario is an active part of the set and available for selection.

By performing in some or all of these ways, the facility enables any user to obtain the benefits of the computational photography technique best-suited to conditions without having to take any special action.

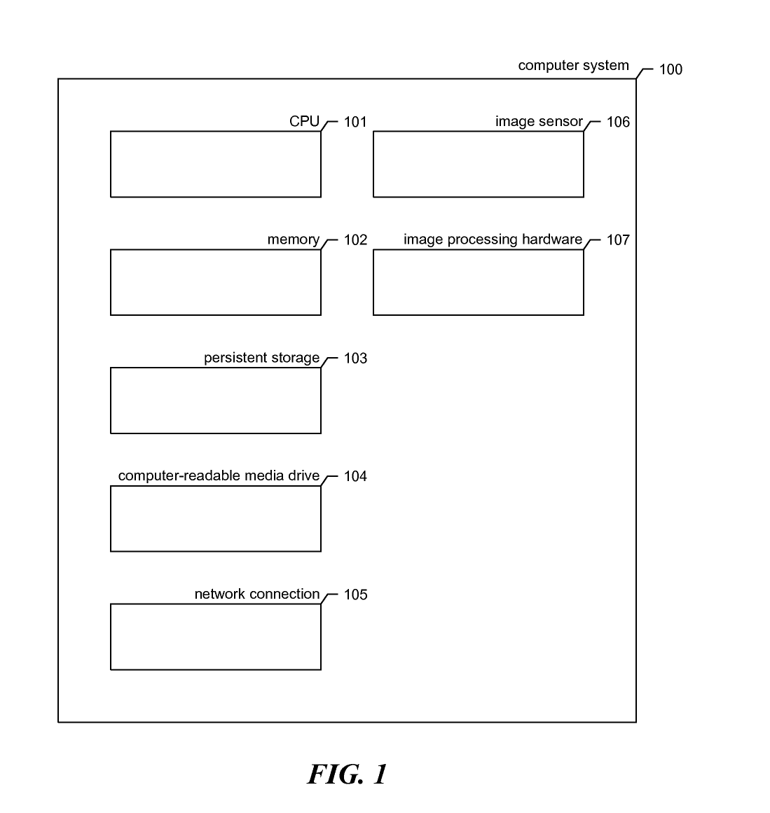

FIG. 1 is a block diagram showing some of the components typically incorporated in at least some of the computer systems and other devices on which the facility operates. In various examples, these computer systems and other devices 100 can include server computer systems, desktop computer systems, laptop computer systems, netbooks, mobile phones, personal digital assistants, televisions, cameras, automobile computers, electronic media players, etc. In various examples, the computer systems and devices include zero or more of each of the following: a central processing unit (“CPU”) 101 for executing computer programs; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. In some examples, the computer system includes an image sensor 106 for capturing photographic images. In some examples, the computer system includes image processing hardware 107 for performing various kinds of processing of images, such as images captured by the image sensor. While computer systems configured as described above are typically used to support the operation of the facility, those skilled in the art will appreciate that the facility may be implemented using devices of various types and configurations, and having various components.

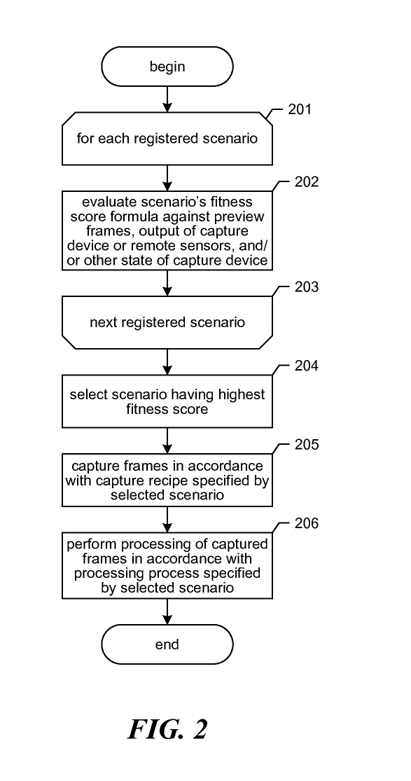

FIG. 2 is a flow diagram showing example acts that may be performed by the facility in some examples to take and process a photograph using an automatically-selected computational photography scenario. In various examples, the facility performs these acts when the user presses the shutter button to take a photo, continuously while the camera is active, or in a variety of other contexts. The facility repeats loop 201-203 for each scenario registered with the facility.

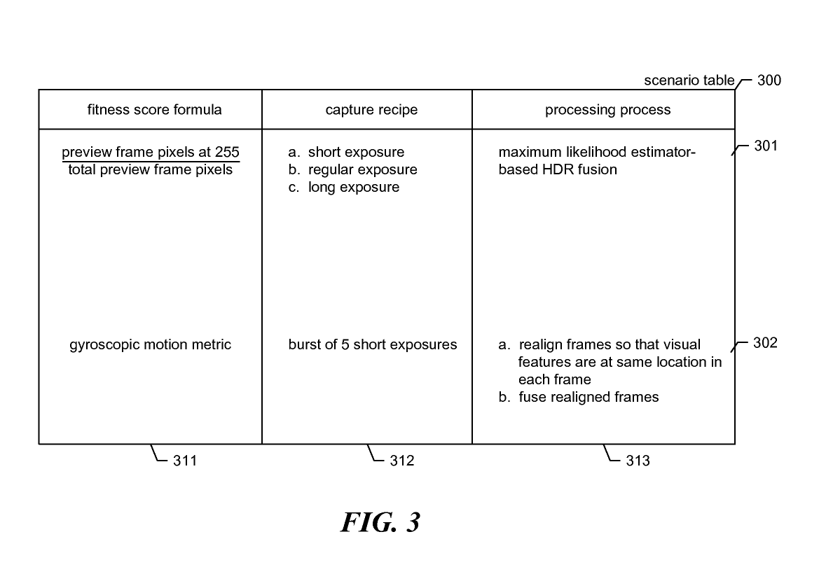

FIG. 3 is a table diagram showing sample contents of a scenario table data structure used by the facility in some examples to store information about registered scenarios. The scenario table 300 is made up of rows, such as rows 301 and 302, each corresponding to a different computational photography scenario. Each row is divided into the following columns: a fitness score formula column 311 indicating how the state of the capture device is to be used to calculate a fitness score indicating how well-suited the scenario to which the row corresponds is to present capture conditions; a capture recipe column 312 that indicates a recipe for capturing a sequence of frames as part of performing the scenario to which the row corresponds; and a processing process column 313 indicating a processing process that is to be performed upon the sequence of frames captured as part of the scenario to which the row corresponds. For example, row 302 corresponds to a digital stabilization scenario. It indicates that the fitness score for this scenario is to be calculated based upon a motion metric produced by a gyroscopic motion sensor included in the capture device. The more significant motion the device is undergoing, the higher the fitness score for the scenario. The row further indicates that, in order to execute the scenario, the capture device is to capture a burst of five short exposure frames. The row further indicates that those frames are to be processed by first realigning them so that visual features occur at the same location in each frame, then fusing the realigned frames. In various examples, the facility represents the contents of the scenario table in various ways. For example, in some examples, the facility represents the contents of the scenario table using a specialized language; in some examples, the facility represents the contents of the scenario table using a general-purpose script language; in some examples, the facility represents the contents of the scenario table by reference to executable code, such as an entry point for the code, a library and function name for the code, etc. In some examples (not shown), the scenario table also includes a column that, for each row, can store one or more conditions that must be fulfilled for the corresponding scenario to be available for fitness testing, selection, and use.

While FIG. 3 shows a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed and/or encrypted; may contain a much larger number of rows than shown, etc.

In some examples, the facility uses some or all of the scenarios described below, together with the bases identified therefore determining each scenario's fitness score.

TABLE 1

| Capture condition | How to measure |
|---|---|
| Low light conditions | histogram + current exposure and ISO |
| | ALS (ambient light sensor) data |
| Low details | count of extracted feature points or |
| | sharpness map |
| High-dynamic scene | Histogram + current exposure and ISO. |
| (sunny, snow . . .) | The image average brightness value |
| | (exposure meter metric) is on target but |
| | some significant areas within the field |
| | of view are left under or overexposed. |
| Camera motion | global alignment result or inertial |
| (shake detection) | measurement unit or sharpness map (blur) |
| Blur amount | high-frequency content/sharpness map |
| In-scene motion | differences after global alignment |
| (action vs. static) | |
| Faces | face detection, smile, blink |
| (portrait, group shot . . .) | |
| Scene distance | AF result and/or face size + camera |
| (macro, flash range, far) | FOV |

In some examples, the facility uses some or all of the capture recipes described in Table 2 below among the scenarios it implements.

TABLE 2

| Detected condition | Capture recipe |
|---|---|
| High dynamic range | Exposure bracketing |
| | (e.g. EV − 1, EV 0, EV + 1) |
| Low light + | Flash/no-flash (the ‘burst of short |
| low details | exposures’ may have difficulties to |
| | complete a successful image alignment) |
| Good features and | Burst of short exposures |
| (Low light or camera motion) | (e.g. burst of EV − 1) |
| Camera motion + | Burst of short exposures (near max ISO, |
| high dynamic range | conservative exposure AE with EV − 1) |
| In-scene motion + | Single shot (traditional 3A approach) + |
| low dynamic range + | optional post-capture enhancement (such |
| good light | as Microsoft Windows Phone Autofix) |
| Complex subject or scene | Focus bracketing |
| distance | |

In some examples, the facility includes among the registered scenarios a scenario in which High Dynamic Range Imaging is performed without exposure bracketing. In particular, the capture recipe is a burst of short-exposure frames and the processing process is to fuse these frames and perform HDR tone mapping and local contrast enhancement techniques.

Returning to FIG. 2, at 202, the facility evaluates each scenario's fitness score formula against a variety of context information reflecting the current environment for taking a photo, including information about preview frames being generated by the image sensor, output of sensors in the capture device, output of sensors remote from the capture device, other state of the capture device such as amount of available memory or processing resources, etc. At 204, having produced a fitness score for each registered scenario, the facility selects the scenario having the highest fitness score. At 205, the facility captures a sequence of frames in accordance with the capture recipe specified by the selected scenario. For example, for the scenario to which row 302 in the scenario table corresponds, the facility captures a burst of five short-exposure frames. At 206, the facility performs processing of the frames captured at 205 in accordance with a processing process specified by the scenario selected at 204. For example, for the scenario to which row 302 corresponds, the facility realigns the captured frames, then fuses them into a single image. After act 206, these acts conclude.

Those skilled in the art will appreciate that the acts shown in FIG. 2 and in each of the flow diagrams discussed below may be altered in a variety of ways. For example, the order of the acts may be rearranged; some acts may be performed in parallel; shown acts may be omitted, or other acts may be included; a shown act may be divided into sub-acts, or multiple shown acts may be combined into a single act, etc.

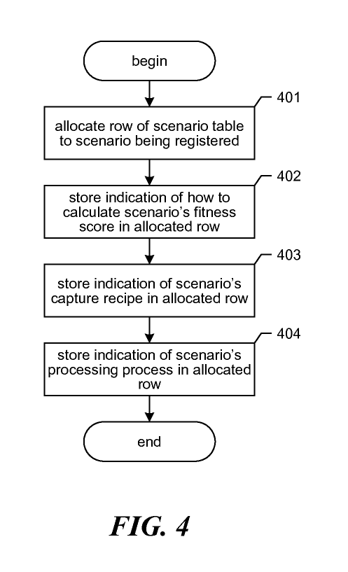

FIG. 4 is a flow diagram showing acts that may be performed by the facility in some examples to add a new scenario to the scenarios registered with the facility. For example, this process may be used to add scenarios defined by the device manufacturer after the device has shipped; scenarios defined by the operating system provider after the operating system has shipped; scenarios defined by a third-party provider; and/or scenarios defined by the end user. At 401, the facility allocates a new row of the scenario table to the new scenario being registered. At 402, the facility stores an indication of how to calculate the new scenario's fitness score in the row allocated at 401. At 403, the facility stored an indication of the scenario's capture recipe in the row allocated at 401. At 404, the facility stores an indication of the scenario's processing process in the row allocated at 401. After act 404, these acts conclude.

In some examples, a method for generating at least one image is provided. The method comprises: for each of a plurality of registered photography scenarios, determining a suitability score for the scenario based upon state of the photography device; selecting a scenario among the plurality of scenarios having a determined score no lower than any other determined score; capturing a sequence of frames in a manner specified for the scenario; and processing the captured sequence of frames in a manner specified for the scenario to obtain at least one image.

In some examples, a computer-readable medium having contents configured to cause a photography device perform a process for generating at least one image is provided. The process comprises: for each of a plurality of registered photography scenarios, determining a suitability score for the scenario based upon state of the photography device; selecting a scenario among the plurality of scenarios having a determined score no lower than any other determined score; capturing a sequence of frames in a manner specified for the scenario; and processing the captured sequence of frames in a manner specified for the scenario to obtain at least one image.

In some examples, a computer-readable memory storing a photography scenario data structure is provided. The data structure comprises: a plurality of entries each representing a photography scenario, each entry comprising: first contents specifying how to determine a suitability score for the photography scenario based upon state information, second contents specifying how to capture a sequence of frames as part of the photography scenario, and third contents specifying how to process the captured sequence of frames as part of the photography scenario, such that the contents of the data structure is usable to determine a suitability score for each photography scenario represented by an entry, to select a photography scenario having a highest suitability score, and to perform frame capture and captured frame processing in accordance with the selected photography scenario.

In some examples, a photography device is provided. The photography device comprises: a scoring subsystem configured to, for each of a plurality of computational photography scenarios, determine a suitability score for the scenario based upon state of the photography device; a scenario selection subsystem configured to select a scenario among the plurality of scenarios having a determined score no lower than any other determined score; an image sensor configured to capture a sequence of frames in a manner specified for the scenario; and a processing subsystem configured to process the sequence of frames captured by the image sensor in a manner specified for the scenario to obtain at least one image.

It will be appreciated by those skilled in the art that the above-described facility may be straightforwardly adapted or extended in various ways. While the foregoing description makes reference to particular examples, the scope of the invention is defined solely by the claims that follow and the elements recited therein.

1. A computer-readable medium having contents configured to cause a photography device perform a process for generating at least one image, the process comprising:
for each of a plurality of registered photography scenarios, determining a suitability score for the scenario based upon state of the photography device;
selecting scenario among the plurality of scenarios having a determined suitability score no lower than any other determined suitability score;
capturing a sequence of one or more frames in a manner specified for the selected scenario; and
processing the captured sequence of frames in a manner specified for the selected scenario to obtain at least one image.

2. The computer-readable medium of claim 1 wherein the processing involves a fusion technique, and produces a single image.

3. The computer-readable medium of claim 1 wherein the processing produces a sequence of images.

4. The computer-readable medium of claim 1 wherein the capturing captures the sequence of frames using for each captured frame at least one configuration setting specified for the scenario.

5. The computer-readable medium of claim 1 wherein the determining uses a process for determining a suitability score specified for the scenario.

6. The computer-readable medium of claim 1 wherein at least one of the generated scores is based on output of an ambient light sensor.

7. The computer-readable medium of claim 1 wherein at least one of the generated scores is based on an aggregation across pixels of a preview image.

8. The computer-readable medium of claim 1 wherein at least one of the generated scores is based on output of a motion sensor.

9. The computer-readable medium of claim 1 wherein at least one of the generated scores is based on information received wirelessly by the photography device.

10. The computer-readable medium of claim 1 wherein the process further comprises:
receiving for a distinguished scenario a process for determining a suitability score for the distinguished scenario, a manner in which to capture a sequence of frames for the distinguished scenario, and a manner in which to process the captured sequence of frames for the distinguished scenario; and
in response to receiving, including the distinguished scenario among the plurality of registered photography scenarios.

11. A computer-readable memory storing a photography scenario data structure, the data structure comprising:
a plurality of entries each representing a photography scenario, each entry comprising:
first contents specifying how to determine a suitability score for the photography scenario based upon state information;
second contents specifying how to capture a sequence of frames as part of the photography scenario; and
third contents specifying how to process the captured sequence of frames as part of the photography scenario,
such that the contents of the data structure is usable to determine a suitability score for each photography scenario represented by an entry, to select a photography scenario having a highest suitability score, and to perform frame capture and captured frame processing in accordance with the selected photography scenario.

12. The computer-readable memory of claim 11 wherein, for each of at least one of the plurality of entries, the second and third contents identify code to be executed.

13. The computer-readable memory of claim 11 wherein, for each of at least one of the plurality of entries, the second and third contents each identify code to be executed by including an entry point.

14. The computer-readable memory of claim 11 wherein, for each of at least one of the plurality of entries, the second and third contents each identify code to be executed by including a function name.

15. The computer-readable memory of claim 11, the data structure further comprising:
for each of at least one of the plurality of entries, a condition that is to be true for the scenario represented by the entry to be considered for use.

16. A photography device comprising:
a scoring subsystem configured to, for each of a plurality of computational photography scenarios, determine a suitability score for the scenario based upon state of the photography device;
a scenario selection subsystem configured to select a scenario among the plurality of scenarios having a determined suitability score no lower than any other determined suitability score;
an image sensor configured to capture a sequence of frames in a manner specified for the selected scenario; and
a processing subsystem configured to process the sequence of frames captured by the image sensor in a manner specified for the selected scenario to obtain at least one image.

17. The photography device of claim 16, further comprising a memory configured to store, for each of the plurality of computational photography scenarios, a scenario definition specifying a way to determine a suitability score for the scenario, a manner to capture a sequence of frames for the scenario, and a manner to process the captured sequence of frames for the scenario.

18. The photography device of claim 17 wherein the memory is updatable, permitting the addition of a computational photography scenario.

19. The photography device of claim 16, further comprising a telephony module for making and receiving voice calls.

20. The photography device of claim 16, further comprising a mechanical interface for interchangeable variable focus lenses.
